(19) United States
(12) Patent Application Publication
(10) Pub. No.: US 2024/0025132 A1
(43) Pub. Date: Jan. 25, 2024

(54) HEATSHIELD EMPLOYING FIBER MATRIX IMPREGNATED WITH POLYPHENYLENE SULFIDE

(71) Applicant: Textron Systems Corporation, Hunt Valley, MD (US)

(72) Inventor: Michael Robert Favaloro, Amesbury, MA (US)

(21) Appl. No.: 18/225,973

(22) Filed: Jul. 25, 2023

Related U.S. Application Data
(60) Provisional application No. 63/391,875, filed on Jul. 25, 2022.

(51) Int. Cl. B29C 70/22; B29C 70/00; B29C 70/54; B29C 70/30

(52) U.S. Cl. CPC B29C 70/228; B29C 70/003; B29C 70/543; B29C 70/30; B29K 2081/04

(57) ABSTRACT

A heatshield is made of a heatshield material including an insulative-fiber matrix fully impregnated with a polyphenylene sulfide resin. The heatshield material may be a multi-layer fiber matrix having higher-weight forms at an outer ablative surface and lower-weight forms more inwardly, for insulation. In one example, PPS fiber is combined with carbon or carbon precursor fibers and both woven into fabric form and manufactured into nonwoven sheet stock. The final tailored stackup may be needled together, and the needled fabric stackup saturated with molten PPS resin.

### BACKGROUND

The invention is in the field of strategic materials and relates specifically to heatshields for hypersonic glide vehicles and cruise missiles as well as other reentry vehicles.

### SUMMARY

A heatshield is disclosed that is made of a heatshield material including an insulative-fiber matrix fully impregnated with a polyphenylene sulfide resin. The heatshield material may be a multi-layer fiber matrix having higher-weight forms at an outer ablative surface and lower-weight forms more inwardly, for insulation. In one example, PPS fiber is combined with carbon or carbon precursor fibers and both woven into fabric form and manufactured into nonwoven sheet stock. The final tailored stackup may be needled together, and the needled fabric stackup saturated with molten PPS resin. A PPS-based heatshield as described may have several advantages over conventional heatshield materials like phenolic, including higher char yield and thus improved ablative performance, and much lower cost by avoiding the need for time-consuming carbon densification processes.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a quasi-schematic illustration of a heatshield applied to a protected structure;

FIG. 2 is a graph showing degradation weight loss of polyphenylene sulfide (PPS) versus phenolic over time;

FIG. 3 is a section view of a PPS-based heatshield material showing layered structure;

FIG. 4 is a section view of a heatshield material showing the use of needling;

FIG. 5 is a section view depicting degradation and melting behavior of the heatshield material during use in a heating stream;

FIG. 6 is a flow diagram of a process of making a PPS-based heatshield material.

### DETAILED DESCRIPTION

Overview

Ablative thermal protection materials (TPM's) are used to protect vehicles from damage due to atmospheric entry. They manage the thermal input of heat with a multiple of processes, including absorption, dissipation, and blockage. In many cases they also act as an aerodynamic body and as a structural member of the vehicle. The major function of a TPM is dependent upon heating rate. For example, when a vehicle decelerates at high altitudes under low pressure conditions and the flight angle with respect to the horizon is low, then the heating rate is low, but the heating time period is long. The Apollo and Space Shuttle trajectories are examples of this environment, and in these cases, material insulation ability becomes important.

Two relevant materials for this kind of application include the Avcoat epoxy novolac material used in the Apollo program and PICA used in many interplanetary missions. Both of these materials provide excellent insulation performance but are relatively expensive. Additionally, the high thermal expansion of these rigid materials result in excessive dimensional changes that must be managed utilizing flexible joints that must also provide insulation while preventing ablative burn-through. The segmented joint approach also adds significant cost to the system.

Another material for this application is a carbon/phenolic composite material for a strategic or hypersonic reentry vehicle. However, phenolic has a relatively low “char yield”, i.e., mass of material remaining after complete degradation, even though phenolic is a baseline ablator because its char yield is higher than other common thermosets such as epoxy. Use of a higher char material would result in improved ablation and related improved product performance. Additional, carbon/phenolic composite process limitations result in structure and design limitations. Thick-walled carbon/phenolic is prone to delamination and some applications require thick-walled heatshields.

Another possible material for this application is a carbon-reinforced carbon (“carbon/carbon”) heatshield for a strategic or hypersonic reentry vehicle. Conventionally, carbon/carbon components are made using a densification process that can be very time consuming, e.g., on the order of a month or longer for some parts and application. Phenolic and pitch are commonly used as impregnator resins to manufacture carbon/carbon, and because of their low char yields, these require multiple cycles to achieve a target density. Use of a higher char material would result in reduced cycle process time to manufacture the carbon/carbon component, reducing delay and cost.

A disclosed approach employs a toughened TPM for atmospheric entry applications that can provide excellent insulation ability combined with improved design options to address thermal expansion plus very low relative cost. The approach involves combining fiber forms of polyphenylene sulfide (PPS), carbon fiber and/or carbon fiber precursor with a PPS matrix into a low-cost tailorable PICA-like product. PPS is a relatively simple polymer having a high carbon content by weight due to its general structure (aromatic rings linked by sulfides) and in particular its semicrystalline dense-packing form. Isothermal thermogravimetric analysis (TGA) and char data show that as the polymer structure decomposes during ablation, it maintains a relatively high residual density of carbon and is thus a good candidate for heatshield applications.

### Description of Embodiments

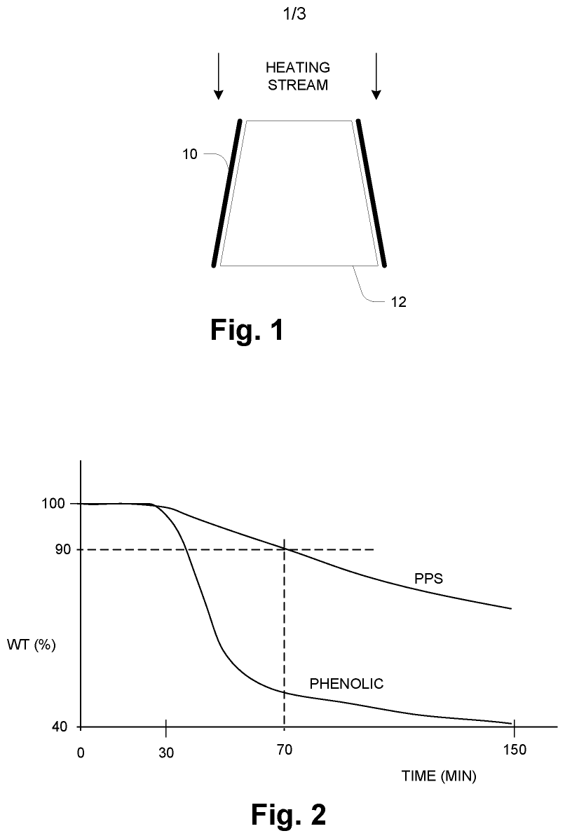

FIG. 1 is a quasi-schematic side view of a PPS-based heatshield material in use, namely as a heatshield 10 applied to a protected structure 12. In this application the protected structure 12 has a frustoconical shape such as that of a nose cone, and the heatshield 10 has a matching shape. The heatshield 10 overlies the outer surface of the protected structure 12 to protect it from damage by a heating stream (e.g., atmospheric gases) during high-speed flight such as atmosphere reentry, long hypersonic glide, etc. As described more below, the heatshield 10 is made of a planar flexible material formed in some manner (e.g., by wrapping) to conform to the outer surface of the protected structure 12, with an outer ablative layer facing outwardly (away from surface of protected structure 12) and an inner insulative layer facing inwardly (toward the surface of protected structure 12). The heatshield 10 may be separately formed (e.g., on a mold) and then assembled with the protected structure 12, or alternatively it may be formed directly onto the protected structure 12, such as by wrapping as mentioned above.

The remaining description focuses on the structure and making of the heatshield material from which the heatshield 10 is made. As described below, the heatshield material has a layered fabric kind of structure. It may be formed in continuous sheets for example. Sheets may be further processed into slit-tape tow if the material is used by a subsequent tape-wrapping process for making the heatshield.

FIG. 2 illustrates a certain advantage of semi-crystalline thermoplastics such as PPS (along with PEEK and PEKK for example), namely that they exhibit relatively high char yield as compared to existing high char ablative materials such as phenolic. These results are for isothermal thermogravimetric analysis (TGA) in nitrogen and air at 450 C. The residual mass of PPS exceeds 90% for tens of minutes (e.g., out to 90 minutes), while phenolic lose over half its weight over the same period. PPS is thus considered a superior candidate because of both its low relative cost and its superior char yield. Ablation testing of carbon/PPS has shown results superior to those for phenolic, PEEK and other materials.

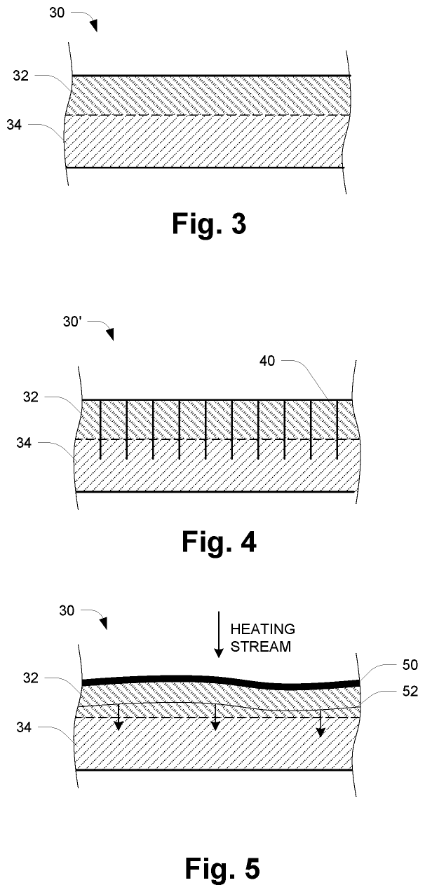

FIG. 3 illustrates a layered structure of heatshield material 30 used to make the heatshield 10. It includes separate layers 32 and 34, with the upper layer 32 intended to face outwardly in use (facing an oncoming heating stream) and the lower layer 34 facing inwardly (toward the protected structure 12). The upper layer 32 is specifically designed and made for high ablation resistance, and thus may also be called the ablative layer 32, while the lower layer 34 is designed and made more for insulation, and thus may be called the insulative layer. Although in this depiction the layers 32, 34 appear distinct and discrete, in practice there may be more gradual gradation of characteristics from the outer surface to the inner surface, as will be appreciated based on the more detailed description below.

PPS resin can be extruded into fiber tows for making products intended for high temperature applications. For one version of the subject heatshield, PPS fiber is combined with carbon or carbon precursor fibers and both woven into fabric form and manufactured into nonwoven sheet stock. The different fiber forms, which correspond to the separate layers 32, 34 of FIG. 3, exhibit a range of fiber aerial weights (FAW). This allows for a tailorable construction in which high FAW forms are laid up at the surface for ablation performance (i.e., layer 32) and lower FAW forms are sequentially incorporated into lower layers for insulation (i.e., layer/region 34). The final tailored stackup may be needled together as described more below. The needled fabric stackup can be readily saturated with molten PPS resin, as PPS exhibits a melt viscosity below 100 centipoises. As the polymer cools and solidifies, shrinkage is minimal and there is no outgassing, i.e., void formation, as compared to phenolic, so the impregnation process for PPS is much more efficient than multiple impregnations and cures of a phenolic based heatshield. The net result is a needled structure fully saturated with a high char yield polymer (PPS) manufactured in a fraction of time typically required for a densified phenolic product. Furthermore, the thermoplastic PPS has a much tougher, more robust form than a phenolic thermoset, which can improve processability, handleability and performance, and may allow for reduction or elimination of thermal expansion joints. Although typical thermoplastic filaments and matrix may exhibit relatively high coefficient of thermal expansion (CTE), the overall structure CTE is reduced by use of low-CTE carbon fiber in the matrix.

FIG. 4 illustrates the use of needling as mentioned above. The heatshield material 30′ has layers 32 and 34 as in FIG. 3, and also includes stitches 40 extending from the top/outer surface down into the layer 34 as shown (not reaching the lower/inner surface). This needling can increase resistance to delamination. Additionally, needling process itself acts to compress the upper layer 32 under the weight of a sewing machine head, favorably increasing its density.

FIG. 5 illustrates performance of the material 30 in use, i.e., under high-temperature ablative conditions in a heating stream such as high-velocity atmospheric gases. The outer layer 32 is ablating and charring at its outer surface, forming char 50. Deeper down, the PPS resin in layer 32 is melting and being forced downwardly into the insulative layer 34, as indicated by line 52 and downward-facing arrows. This action helps increase the ablation resistance of the lower layer 34 at a later time when it is directly exposed to the heating stream, after the upper layer 32 has completely ablated away.

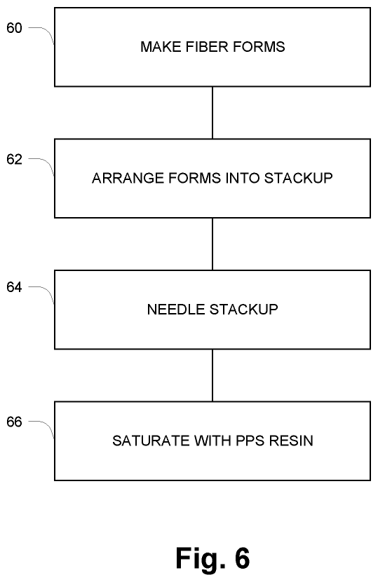

FIG. 6 is a high-level flow diagram description of a method of making heatshield material 30. At 60, different fiber forms are made which exhibit a range of fiber aerial weights (FAW). In one embodiment, PPS fiber is combined with carbon or carbon precursor fibers and both woven into fabric form and manufactured into nonwoven sheet stock. At 62, the forms are arranged into a construction in which high FAW forms are laid up at one surface for ablation performance (i.e., layer 32) and lower FAW forms are sequentially incorporated into lower layers for insulation (i.e., layer/region 34). At 64, the tailored stackup may be needled together. At 66, the needled fabric stackup is saturated with molten PPS resin.

Cost savings associated with a PPS-based heatshield may be as follows:
1) Single impregnation with a low viscosity, low-cost PPS matrix is less expensive and much faster than multiple impregnations of a phenolic-based system as is done with PICA.
2) A design solution to manage a flexible toughened TPM with few or no joints is feasible.

Limitations of the disclosed approach may be due to material thickness limitations in the needling process and the available width of fabric/broadgood. Although carbon and PPS thermoplastic fibers are specifically contemplated, other fibers such as glass and quartz fibers may also be incorporated. Density ranges can vary according to weave type ranging between 50 to 500 gsm. Fabric density ranges and sizes are only based on commercially available types. For example, 100 inch wide fabric or larger based upon jacquard loom-manufactured paper machinery clothing fabric belt sizes, can be utilized as necessary. Needled thickness can exceed two inches or more depending upon needs. Scaleup limitations may be an issue with extensive fabric thicknesses in excess of 5 inches. Seamless preforms are possible with very wide fabrics as they are commercially available.

In another embodiment, a bias reinforced carbon fabric is saturated with PPS resin and used on a tape wrapped strategic or hypersonic vehicle. The processability of carbon/PPS allows for very thick walled heatshields, up to several inches, as opposed to conventional carbon/phenolic heatshields, which are typically less than one inch thick. Very high char yield results in significant improvement in ablation performance of the vehicle, and ease of manufacture allows for more complex vehicle shapes and designs.

In yet another embodiment, a carbon/PPS part is converted into carbon/carbon using a carbon/carbon densifications processes, as generally known in the art. The higher char yield of the PPS resin can reduce processing time and result in a much lower cost component.

Overall, the significantly higher char yield of PPS versus other materials such as phenolic results in improved ablation performance as a heatshield. Because PPS is a thermoplastic, it can be converted to fiber form allowing for ablative reinforced forms to be manufactured. Also, because thermoplastics such as PPS are polymers, as opposed to thermosets like phenolic which start as uncured monomers, they allow for thick walled parts to be manufactured without significant process limitations. Conversion of thermoset monomers to polymers requires time and pressure to form to shape, where thermoplastic polymers can be quickly heated, reformed, and cooled to shape.

While various embodiments of the invention have been particularly shown and described, it will be understood by those skilled in the art that various changes in form and details may be made therein without departing from the scope of the invention as defined by the appended claims.

What is claimed is:

1. A heatshield, comprising a heatshield material including an insulative-fiber matrix fully impregnated with a polyphenylene sulfide resin.

2. The heatshield of claim 1, formed of a multi-layer fiber matrix having higher-weight forms at an outer ablative surface and lower-weight forms more inwardly, for insulation.

3. The heatshield of claim 2, wherein the fiber matrix includes polyphenylene sulfide fiber combined with carbon or carbon precursor fibers and both woven into fabric form and manufactured into nonwoven sheet stock.

4. The heatshield of claim 2, wherein the fiber forms are needled together to form a needled stackup, and the needled fabric stackup is saturated with molten polyphenylene sulfide resin.

5. The heatshield of claim 4, wherein the needled stackup includes stitches extending from a top surface down into a lower layer without reaching lower surface.

6. The heatshield of claim 5, wherein an outer layer at the top surface has an increased density resulting from the needling.

7. A method of making a heatshield, comprising:
1) making a heatshield material by:
making a set of fiber forms which exhibit a range of fiber aerial weights (FAW);
arranging the forms into a constructions in which high FAW forms are laid up at one surface for ablation performance and lower FAW forms are sequentially incorporated into lower layers for insulation, to form a tailored stackup; and
needling the tailored stackup together and saturating the needled stackup with molten polyphenylene sulfide resin; and
2) forming and processing the heatshield material into the heatshield.

8. The method of claim 7, wherein forming and processing the heatshield material includes forming the heatshield material into a conical shape corresponding to a nosecone of a high-velocity vehicle.

9. The method of claim 7, wherein making the set of fiber forms includes combining polyphenylene sulfide fiber with carbon or carbon precursor fibers and waving into fabric form.

10. The method of claim 7, further including needling the fiber forms together to form a needled stackup, and suturing the needled fabric stackup with molten polyphenylene sulfide resin.

11. The method of claim 10, wherein the needled stackup includes stitches extending from a top surface down into a lower layer without reaching lower surface.

12. The method of claim 11, wherein the needling includes compressing an outer layer at the top surface to increase its density.

13. The method of claim 7, wherein forming and processing the heatshield material includes using a carbon/carbon densification process to converted the heatshield material into carbon/carbon.
